(19) United States
(12) Patent Application Publication
(10) Pub. No.: US 2005/0278709 A1
(43) Pub. Date: Dec. 15, 2005

(54) Resource definition language for network management application development

(76) Inventors: Manjula Sridhar, Lisle, IL (US); Edward G. Brunell, Chicago, IL (US); Shankar Krishnamoorthy, Scotch Plains, NJ (US); Xiangyang Shen, Naperville, IL (US); Dong Zhao, Lisle, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/868,375

(22) Filed: Jun. 15, 2004

(51) Int. Cl. G06F 9/45

(52) U.S. Cl. 717/136; 717/115; 717/116

(57) ABSTRACT

Methods of defining a distributed system or network to facilitate development of an application program to manage the distributed system or network are provided. In one embodiment, the method includes: a) defining managed objects in a resource definition language and storing the definition in resource definition language files, wherein the definition is based on an existing design and hierarchical structure of the distributed system or network, wherein parent-child relationships between the managed objects are identified in the resource definition language files using the resource definition language to define the managed objects in relation to the hierarchical structure, b) parsing the resource definition language files to ensure conformity with the resource definition language and creating an intermediate representation of the distributed system or network from the conforming resource definition language files, and c) processing the intermediate representation to form programming language classes, database definition files, and script files.

### CROSS-REFERENCE TO RELATED APPLICATIONS

This application is related to Zhao et al., Ser. No. ______ Attorney Docket No. LUTZ 2 00268 and Lucent Case Name/No. Brunell 1-1-1-1-1, entitled “Run-Time Tool for Network Management Application,” filed Jun. 15, 2004, commonly assigned to Lucent Technologies, Inc. and incorporated by reference herein.

This application is related to Brunell et al., Ser. No. ______ Attorney Docket No. LUTZ 2 00324 and Lucent Case Name/No. Brunell 3-3-3-3-3, entitled “View Definition Language for Network Management Application Development,” filed Jun. 15, 2004, commonly assigned to Lucent Technologies, Inc. and incorporated by reference herein.

This application is related to Brunell et al., Ser. No. ______ Attorney Docket No. LUTZ 2 00323 and Lucent Case Name/No. Brunell 4-1-4-4-4-4, entitled “Distribution Adaptor for Network Management Application Development,” filed Jun. 15, 2004, commonly assigned to Lucent Technologies, Inc. and incorporated by reference herein.

This application is related to Zhao et al., Ser. No. ______ Attorney Docket No. LUTZ 2 00325 and Lucent Case Name/No. Brunell 5-2-5-5-5, entitled “Event Management Framework for Network Management Application Development,” filed Jun. 15, 2004, commonly assigned to Lucent Technologies, Inc. and incorporated by reference herein.

This application is related to Sridner et al., Ser. No. ______ Attorney Docket No. LUTZ 2 00326 and Lucent Case Name/No. Brunell 6-1-6-5-6-6, entitled “Managed Object Framework for Network Management Application Development,” filed Jun. 15, 2004, commonly assigned to Lucent Technologies, Inc. and incorporated by reference herein.

This application is related to Shen et al., Ser. No. ______ Attorney Docket No. LUTZ 2 00327 and Lucent Case Name/No. Brunell 7-7-6-7-7, entitled “Data Management and Persistence Frameworks for Network Management Application Development,” filed Jun. 15, 2004, commonly assigned to Lucent Technologies, Inc. and incorporated by reference herein.

This application is related to Sridner et al., Ser. No. ______ Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to development of a network management application and, more particularly, to a resource definition language and associated commands, parsers, and code generators for network management application development.

While the invention is particularly directed to the art of network management application development, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN.1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN.1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN.1 macro, TEXTUAL-CONVENTION, is used to concisely convey the syntax and semantics of a textual convention.

RFC 2580, Conformance Statements for SMIv2, defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates a resource definition language for network management application development that resolves the above-referenced difficulties and others.

### SUMMARY OF THE INVENTION

A method of defining a distributed system to facilitate development of an application program to manage the distributed system is provided. In one aspect, the method includes: a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system, b) parsing the one or more resource definition language files to ensure conformity with the object-oriented resource definition language and creating an intermediate representation of the distributed system from the one or more conforming resource definition language files, and c) processing the intermediate representation of the distributed system to form one or more programming language classes, one or more database definition files, and one or more script files.

A method of defining a network to facilitate development of an application program to manage the network is also provided. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network created in the parsing step includes a parse tree, and c) processing the parse tree to form one or more programming language classes, wherein the one or more programming language classes formed include at least one of one or more system classes, one or more module classes, one or more managed object classes, and one or more composite attribute classes.

In another aspect of the method of defining a network to facilitate development of an application program to manage the network, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network includes object meta-data, and c) processing the object meta-data to form one or more programming language classes, one or more database definition files, and one or more script files, wherein the one or more programming language classes formed include at least one of an index class and a query class.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a RAC development environment for generating managed object definition language (MODL) code.

FIG. 10 is a block diagram of an embodiment of a typical MODL file of the RAC development environment.

FIG. 11 is a block diagram of an embodiment of system classes of MODL code generated by the RAC development environment.

FIG. 12 is a block diagram of an embodiment of module classes of MODL code generated by the RAC development environment.

FIG. 13 is a block diagram of an embodiment of managed object classes of MODL code generated by the RAC development environment.

FIG. 14 is a block diagram of an embodiment of composite attribute classes of MODL code generated by the RAC development environment.

FIG. 15 is a block diagram of an embodiment of a RAC development environment for generating database management code.

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1) creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be re-generated. Thus, streamlining change management of the network management application. The revised network management application is provided in a consistent and controlled manner through the object-oriented programming characteristics of MODL and the RAC management framework.

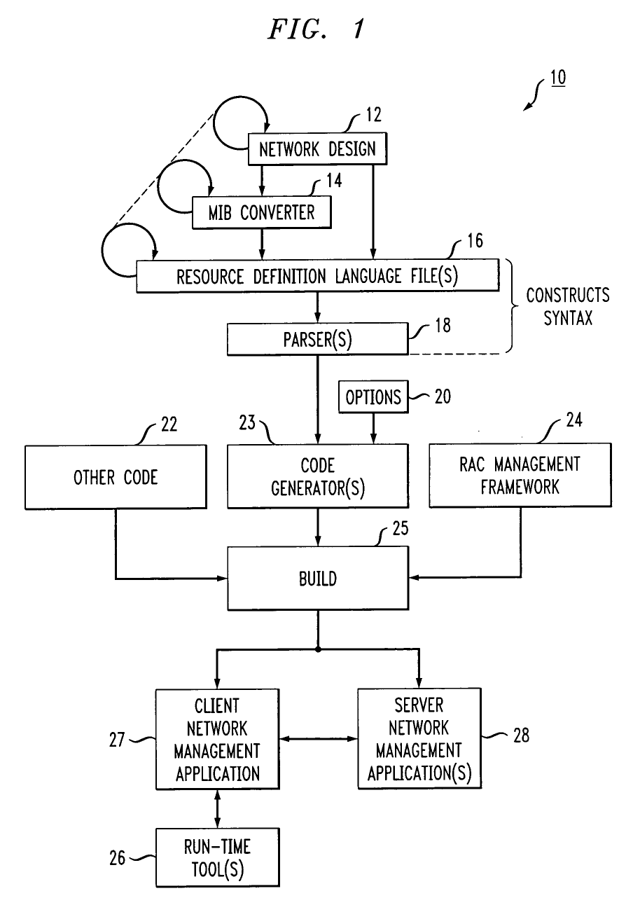

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

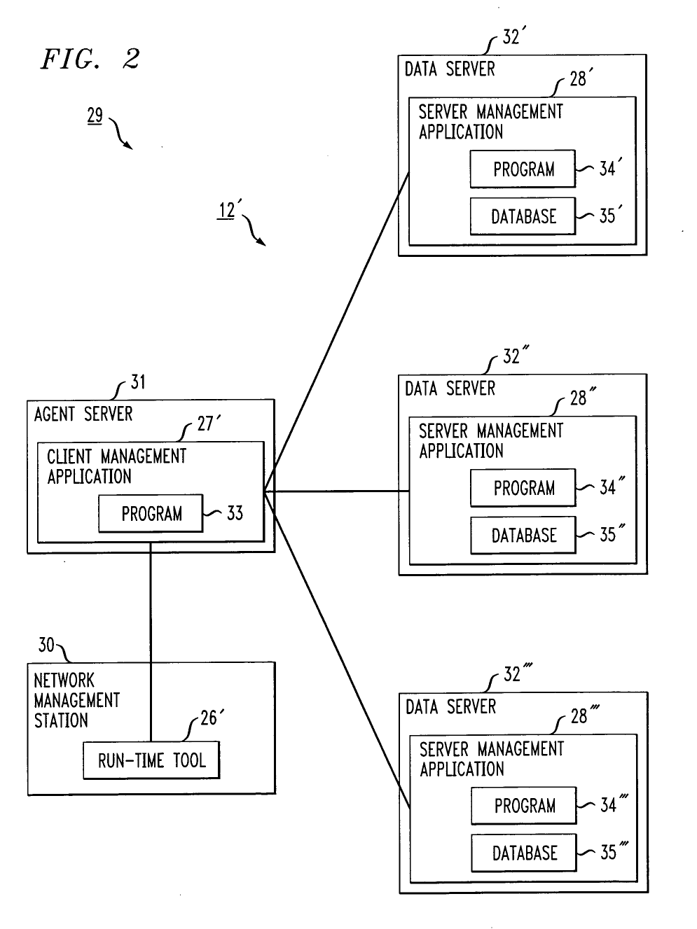

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32″, 32′″ each include a corresponding embodiment of the server network management application 28′, 28″, 28′″. The client network management application 27′ includes an application program 33. Each server network management application 28′, 28″, 28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

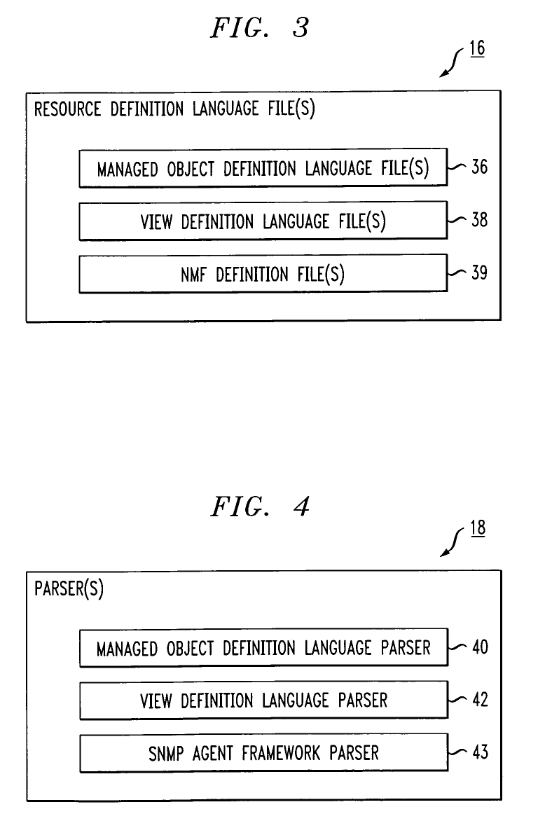

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

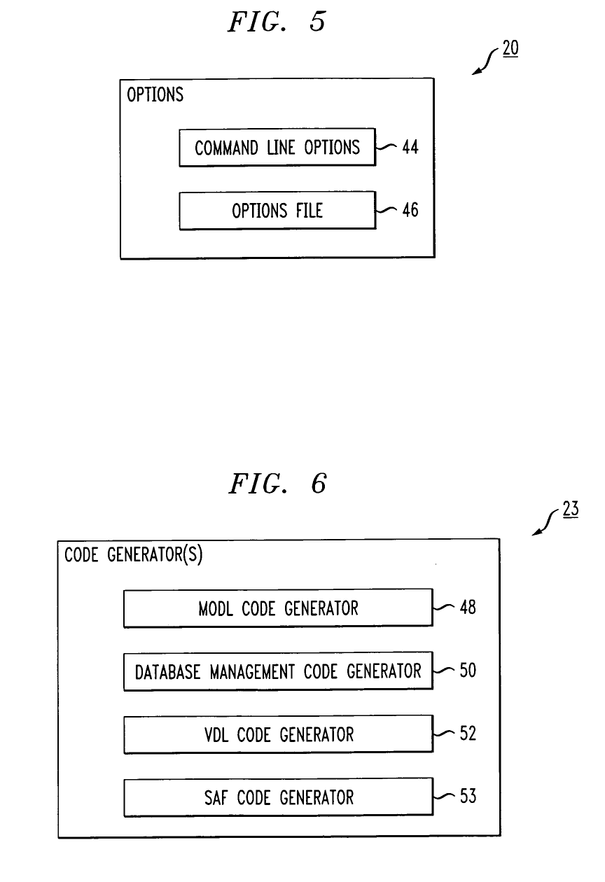

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

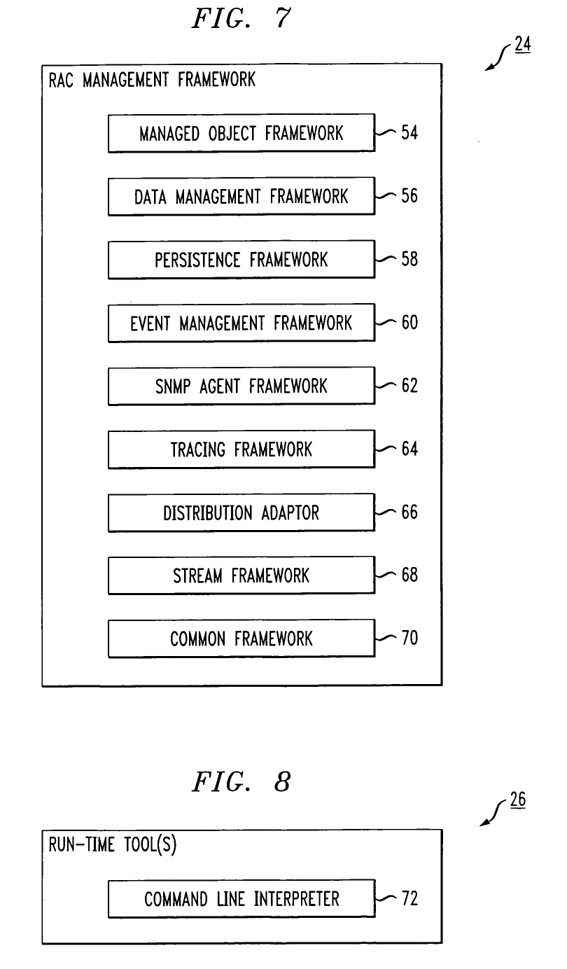

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

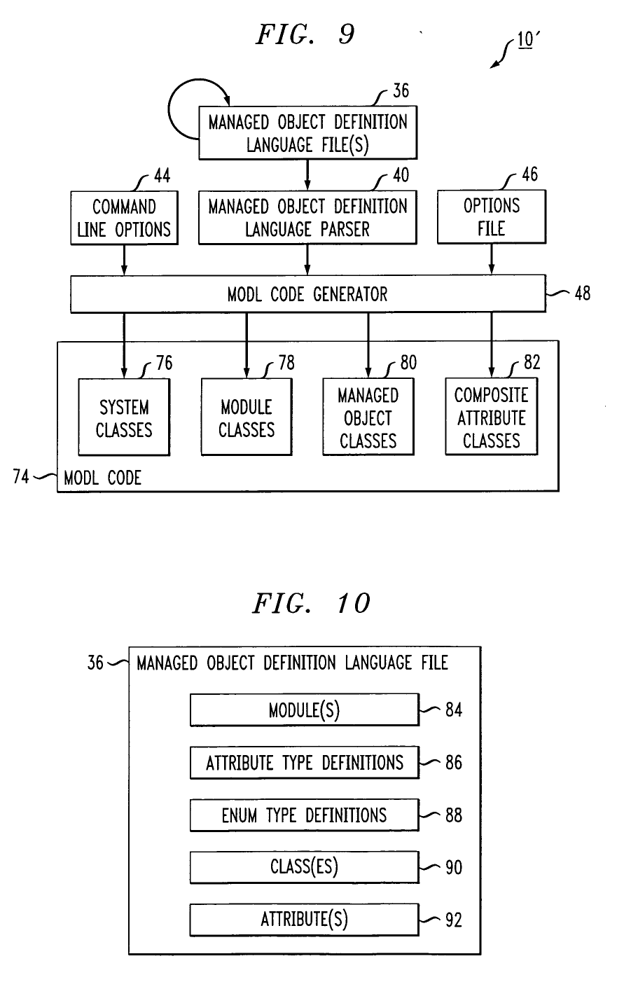

With reference to FIG. 9, an embodiment of a RAC development environment 10′ for generating MODL code includes the MODL file(s) 36, MODL parser 40, command line options 44, options file 46, MODL code generator 48, and MODL code 74. The MODL code 74 includes system classes 76, module classes 78, managed object classes 80, and composite attribute classes 82. As described above in reference to FIGS. 1 and 3, the MODL file(s) 36 are prepared and provided to the MODL parser 40. The MODL parser 40 parses the file(s) and provides a parse tree to the MODL code generator 48 as described above in reference to FIGS. 1 and 4. If implemented, the options file 46 is prepared and provided to the MODL code generator 48 as described above in reference to FIGS. 1 and 5. A command to initiate the MODL code generator 48 is entered with selected command line options 44 and executed as described above in reference to FIGS. 1 and 5. The MODL code generator 48 generates MODL code that includes system classes 76, module classes 78, managed object classes 80, and composite attribute classes 82 as described above in reference to FIGS. 1 and 6.

With reference to FIG. 10, an embodiment of a typical MODL file 36 includes a module(s) 84, attribute type definitions 86, enum type definitions 88, class(es) 90, and attribute(s) 92. MODL is used to define the managed resources. MODL allows for definition of managed resources as managed object classes. Thus, a class 90 corresponds to a managed resource. Each managed resource can have one or more managed objects. An attribute 92 corresponds to a managed object. MODL consists of constructs to organize the data models in a set of MODL file(s) 36. This facilitates easy readability and provides a mechanism for abstracting the managed resources and objects in the network design. A typical MODL file, for example, includes a .odl extension and is structured as follows:

```
Module <module name>
{
//Attribute type definitions
//Enum type definitions
Class <<classname>>
    {
        index {
Attribute1 ...
Attributen.
            }
            Attribute attr1;
            Attribute attr2;
            Attribute attr3;
    }
}
```

MODL includes a number of reserved keywords. For example, the reserved keywords may include module, Class, AttributeType, index, const, Valid, readonly, extends, implements, enum, action, in, and out. The table below provides the general meaning for each MODL keyword:

| KEYWORD | MEANING |
|---|---|
| module | Used for module. |
| Class | Used to specify a managed object. |
| AttributeType | Used to specify composite attribute (user |
| | defined data type, similar to structures) |
| index | Used to specify the index of a managed object. |
| const | Used to specify the constness of a data member |
| | (Attribute) |
| Valid | Used for RANGE specifications. |
| readonly | Used to specify readonly attribute types. |
| extends | Used to denote inheritance. |
| implements | Used to specify the implementation. |
| enum | Used for enum types. |
| action | Used to specify methods of an managed object. |
| in | Used to denote input parameter of an action. |
| out | Used to denote output parameter of an action. |

The module 84 is the highest level of abstraction in MODL and is analogous to a C++ name space. Modules 84 are used to logically group the MODL types, such as enum, attribute types, managed objects, and other module declarations. A module declaration is not restricted to a single physical file (i.e., developers can add definitions to a module from several module declarations in the same or different MODL files. The syntax for a module declarations is as follows:

```
module <<modulename>> {
    (EnumDeclaration|AttributeTypeDeclaration|
      ClassDeclaration|ModuleDeclaration)
};
```

As shown in the syntax, a module 84 may consist of one or more enum declarations, managed object declarations, attribute type declarations, or other module declarations. A module 84 can access data types in other modules by appending <<modulename>> with the qualifier (“.”) and the name of the data type. For example, module X can access enum YY in module Y as shown below:

```
module X {
    enum XX ...
    module Y {
        enum YY ...
    };
};
```

The enum “XX” in module “X” can be accessed from another module as “X.XX.” Similarly, enum “YY” in module “X” can be accessed from another module as “X.Y.YY.” The types can also be accessed relatively. For example, within the module “X”, type “XX” can be accessed as “XX” and type “YY” can be accessed as “Y.YY”. An implicit module, referred to as root module, contains all the type declaration in an MODL file that are not under any module. The root module also contains all the top-level module declarations.

Class 90 is the unit of abstraction in MODL that is available at the interfaces for access. All MOF operations are operated on managed object class. The class specification of a managed object class contains the name of the class, any special property of the managed object, the index specification, and the attribute declaration. The syntax for a class specification is as follows:

```
class <<managed object class name>> {
    [(ImplementsDeclaration [ExtendsDeclaration]) |
      (ExtendsDeclaration [ImplementsDeclaration])]
    <Index Declaration>
    (<Attribute Declaration>)*
    (<Action Declaration>)*
};
```

An example of a class declaration is as shown below. In the example, the class name is OverloadControlSec. The class belongs to a group named Bts.Sector. The group specification is optional. If no group is specified, then root group is assumed. The group specification is used to hierarchically group the managed objects.

```
class OverloadControlSec
{ # class name specification
  group Bts.Sector; # optional group specification
  index
{ # index of the managed object specification
    const Integer BscCfg = 1; # attributes can have a
default value.
    Integer BtsCfg;
    Integer SectorCfg;
    const Integer OverloadControlSec = 1;
      };
  # attributes specification
  Integer FpcPilotGain;
  IpAddress BtsIpAddress;
  DisplayString Version;
  PersonalityType Personality;
};
```

Classes 90 in a module 84 can have various relationships, such as implementation of another managed object (implements declaration), inheritance of attributes of another managed object (extends declaration), combinations of implementation and inheritance, and parent-child relationships (index).

An implements declaration is provided by the implements keyword and specifies that the given managed object is an implementation of another managed object. The syntax for an implements declaration is as shown below. FullyQualifiedName is the name of the managed object optionally qualified by its module name.

Implements <<FullyQualifiedName>>

A given managed object can be the implementation of one other managed object. An example of an implementation specification is provided below. In this example, the interface managed object Bts has been implemented by two managed objects—BtsCfg and BtsDynamic. It should be noted that the Bts managed object does not physically exist in the given network element. Bts provides an external interface and acts as proxy. On receiving this request, the MOF agent server automatically redirects these requests to managed object servers containing the implementation managed objects. BtsCfg and BtsDynamic managed objects may not be known to NMS, since they represent how a given managed object is split into multiple managed objects because of implementation constraints.

```
class Bts {
    index {
        const Integer Bsc = 1;
        Integer Bts;
    };
    DisplayString Descr;
    NeType Type;
    UnsignedInteger Uptime;
    DisplayString Name;
    DisplayString Contact;
    DisplayString Location;
    Rac.AlarmSeverityType AlarmLevel;
    ConnInitCommandType InitCommand;
    Rac.AdministrativeStateType AdminState;
    Rac.OperationalStateType OpState;
    Rac.UsageStateType UsageState;
};
class BtsCfg implements Bts {
    index {
        const Integer Bsc = 1;
        Integer BtsCfg;
    };
    DisplayString Descr;
    NeType Type;
    UnsignedInteger Uptime;
    DisplayString Name;
    DisplayString Contact;
    DisplayString Location;
};
class BtsDynamic implements Bts {
    index {
        const Integer Bsc = 1;
        Integer BtsDynamic;
    };
    NeType Type;
    Rac.AlarmSeverityType AlarmLevel;
    ConnInitCommandType InitCommand;
    Rac.AdministrativeStateType AdminState;
    Rac.OperationalStateType OpState;
    Rac.UsageStateType UsageState;
};
```

Once a managed object implements a given managed object X, then X will only be an interface managed object and there cannot be any other implementation of X. So all the attributes of X will have to be implemented by some managed object. Consider the following exemplary implements specification:

```
class X {
    Integer A;
    Integer B;
};
class Y implements X {
    Integer A;
};
```

In the exemplary case, the attribute “B” is not implemented by any managed object. Since “Y” implements “X,” there cannot be an implementation of X. At this point, whenever the NMS requests attribute “B” of class “X” there is no managed object that implements attribute “B.” If this poses a problem, one solution is to introduce another managed object “Z” having the following implements declaration:

class Z implements X {
Integer B;
};

A given managed can inherit all the attributes of another managed object through an extends declaration which is implemented using the extends keyword. The syntax for an extends declaration is shown below. FullyQualifiedName is the name of the managed object optionally qualified by its module name.

Extends <<FullyQualifiedName>>

A given managed object can be inherited by one other managed object. The inheritance specification is introduced in MODL to reuse existing managed object implementations. It is assumed a common information model is already available for other network elements. Once available, managed objects can be specified in another MODL file, implementation of the managed object can be generated and modified by the developers, and a library of managed object implementations are made available. An example of a managed object inheriting from another managed object through an extends specification is provided below. In this example the NetworkElement managed object inherits the attributes of Tmn managed object. Bsc inherits the attributes of NetworkElement, thus inheriting the attribute of Tmn as well. Bsc is extended from NetworkElement to specify the proper containment hierarchy.

```
class Tmn {
    AdministrativeStateType AdminState;
    OperationalStateType OpState;
    UsageStateType UsageState;
};
class NetworkElement extends Tmn {
    index {
        const Integer Rac = 1;
        const Integer NetworkElementId = 1;
    };
    DisplayString Descr;
    NeType Type;
    UnsignedInteger Uptime;
    DisplayString Name;
    DisplayString Contact;
    DisplayString Location;
    AlarmSeverityType AlarmLevel;
    ConnInitCommandType InitCommand;
};
class Bsc extends NetworkElement {
    index {
        const Integer Bsc = 1;
    };
};
```

In MODL the index declaration specifies where the managed object will be contained in the management containment tree. However, using the extend specification, the Bsc class can inherit attributes from another managed object in the containment tree. The distinguished name of the inherited base class is ignored and the most derived class distinguished name is used to identify the hierarchy of the managed object in the containment tree.

The inheritance and implementation combination is bit more complicated. In this type of relationship, the implementation declaration is specified for the most derived class. If there is an implements declaration for the base class, it will be ignored by the derived class. An exemplary implements and extends combination is provided below. In this example, the attributes Type and Name are contained by the BscStatic managed object. The BscDynamic managed object contains the rest of the attribute. The Bsc will ignore any implements declaration that is specified on the NetworkElement.

```
    class Bsc extends Wireless.NetworkElement {
        index {
            const Integer Bsc = 1;
        };
    };
    class BscStatic implements Bsc{
        index {
            const Integer BscStatic = 1;
        };
        Wireless.NeType Type;
        DisplayString Name;
    };
    class BscDynamic implements Bsc extends
Wireless.NetworkElement{
        index {
            const Integer BscDynamic = 1;
        };
    };
```

Parent-child relationships are a type of containment relationship. In MODL, an index declaration is used to determine if a class is a parent or child of another class. The index declaration is implemented using the index keyword. An example of an index declaration showing a parent-child relationship is shown below. Class C is considered a child of Class A because Class C's index contains Class A's index parameters and additional index parameters.

```
Class C {
        index {
            Integer indexA;
            Integer indexC;
                }
      Integer attrc;
    }
```

Parent-child relationships determine the order of storing, accessing, and retrieving the managed objects. Multiple containment is not available (i.e., a child cannot have two parents at the same level). However, multiple levels of containment are available (e.g., Class C can have a child and this child is also considered a child of A). Parent-child relations such as these form the tree structure for the network design.

The index declaration may also declare the index of a corresponding managed object through a list of attribute declarations. The numbers of the attributes contained in the index declaration determine the position/level of the managed object in the containment tree. The syntax for an index declaration is as shown below.

index {
(<Attribute Declaration > + )
};

An example of an index declarations is provided below:

```
index {
    const Integer BscCfg = 1;
    Integer BtsCfg;
    Integer FrameCfg;
};
```

The index declaration is used to uniquely identify an object throughout the system, hence an index declaration is unique throughout the MODL files. Index is also used to define parent-child relationships, as described with regard to containment relationships.

Each managed object class 90 includes one or more managed objects identified by an attribute declaration. The syntax for an attribute declaration is as shown below. The type is the type of the attribute. The name is the name of the attribute. The size is optional and specifies the size of the attribute. The type will be either a fully qualified type or relative to the given module. In the case of a DisplayString, for example, the size can be used to specify the size of the string. If const precedes the attribute, the attribute is considered to have a constant value. The const declaration will be used for index declarations. If readonly precedes the attribute, the attribute cannot be modified by the NMS. Valid values for the attribute may be specified, but are optional.

```
[const][readonly] <AttributeType>[size]
  <<Attribute Name>> [=<<default value>>]
  [valid <<values>>];
```

Some additional examples of attribute declarations are provided below. In the first example, an attribute is declared for an Integer A with no default value. In this example, a default value of 0 is assumed. In the second example, an attribute is declared for an integer B with a default value of 10. In the third example, an attribute is declared for an integer C with a default 100 and valid values from 50 to 150. In the fourth example, an attribute is declared for a 32-bit display string D with an initialize value of “YY.” In the fifth example, an attribute is declared for a variable whose type is enum and initialize with the symbolic constant value “enabled.” The sixth example shows the use of a qualified type.
Integer A;
Integer B=10;
Integer C=100 valid {50−150}.
DisplayString(32) D=“YY”;
OperationalState OpState=enabled; Rac.AdministrativeStateType AdminState=unlocked;

An action declaration may be specified for a given managed object class in MODL. The action specification occurs under the class specification. An action specification is identified by name and contains input and output parameters. The action name is unique within the given class. The syntax for an action declaration is as shown below. An output parameter can be used as a return parameter by the application.
action <<action name>> (((in <<input parameter>>)+)|((out <<output parameter>>)+)*)

Some examples of action declarations are provided below:

```
    action lockBts( in Integer btsId, out Integer Result
);
    action action1( in Integer param1, in IpAddress
param2, out DisplayString param3);
```

Built-in attributes are attribute types that MODL provides to developers. The following built-in attribute types are provided by MODL:
Int, Int32, and Integer represent the attribute type “Integer” (Integer is equivalent to C++ Integer and is mapped to IntegerAttribute in the RAC management framework);
Uint, Uint32, and UnsignedInteger represent the attribute type “UnsignedInteger” (UnsignedInteger is equivalent to unsigned int in C++ and maps accordingly);
Int64 and DoubleInteger represent the attribute type “DoubleInteger”;
Float represents the attribute type “Float”;
Double represents the attribute type “double”;
String and DisplayString represent the attribute type “DisplayString”;
IpAddr and IpAddress represent the attribute type “IpAddress”;
Moid and DistinguishedName represent the attribute type “DistinguishedName”;
Octet and OctetString represent the attribute type “OctetString”; and
Sequence represents the attribute type “Sequence.”

Sometimes the built-in attribute types are not sufficient to describe a managed resource. If so, developers use the AttributeType keyword to declare additional attribute types (i.e., composite attributes). The syntax for a composite attribute declaration is provided below. <Attribute Type Name> is the type name of the composite attribute.

AttributeType <<Attribute Type Name>> {
[(<Attribute Declaration >) + ]
};

Some examples of attribute declarations are provided below. In the first example, an attribute type IpAddress is introduced. Since this is not a built-in attribute type, this is a composite attribute. Since the contents of IpAddress are not declared, during compilation the compiler will not know its contents. In the second example, another composite attribute type ConnectionId is introduced and its contents are properly declared. During compilation, the compiler will know the contents of ConnectionId.

```
AttributeType IpAddress;
AttributeType ConnectionId {
  Integer Id;
  DisplayString(32) src;
  DisplayString(32) Dest;
};
```

Attribute properties provide additional descriptions for attributes apart from the name and types in MODL. The properties provide information such as default values, constraints on the values (e.g., valid ranges), and accessibility options. Attribute properties are applied both to built in and composite attribute types.

The default values for an attribute can be specified in MODL within the attribute declaration. In other words, the default values are set during managed object instantiation as part of constructor. The default values are specified using “=” construct when declaring the attribute. Several examples of an attribute declaration that specifies a default value are provided below:
Integer aInt=100;
DisplayString text=“Hello”;

The constraints on the values, such as a valid range, of an attribute can be declared in MODL using the Valid keyword. The syntax for a Valid declaration is as shown below. The Constant is the constant value of the attribute.
Valid {( Constant|(Constant−Constant) (,) ?)+};

Examples of Valid declarations are provided below. In the first example, the valid range of the integer A is from 1 to 10. In the second example, the valid range of the integer B is from 1 to 20, excluding 11. In the third example, valid values of NetworkElementId include Bsc, Sdn, Msc, and Bts. In the fourth example, the valid range for a Sequence type is from 1 to 100. This implies all the elements of Sequence are between 1 and 100, inclusive.
Integer A Valid {1−10};
Integer B Valid {1−10, 12−20};
DisplayString(10) NetworkElementId Valid {“Bsc”, “Sdu”, “Msc”, “Bts”}=“Sdu”;
Sequence<int,4> Valid {1−100};

Accessibility to attributes can be established using, for example, the readonly or const keywords. The readonly keyword is used to specify an attribute as a read-only attribute. When defined as readonly, no set operation is done on this attribute. The const keyword permits a set operation if the set value is equal to the const value.

An enum declaration is implemented in MODL using the enum keyword and provides a valid range of values for the attributes, as well as some meaningful symbolic constant when presenting the contents. By default, the constants start at 0, but another value can be assigned. Examples of enum declarations are provided below:

```
enum OperationalState {
    enabled,
    disabled
};
enum PersonalityType {
  noPersonality = 0,
  pilotSyncAccess = 1,
  psaPaging = 2,
};
```

Whenever # is encountered in the input line, the rest of the line is considered a comment and ignored during subsequent code generation and build processes. However, if # appears within quotes, it is not treated as a comment. Comments can also be specified using /* ... ... */.

An example of an MODL file is provided below:

| module ViewTest{ | |
|---|---|
| AttributeType CompAttr { | |
| Integer cInt1 = 2 valid {1,2,3,4, “−4”-”−1”, “− | |
| 15”-”−7”} ; | |
| Double d2 = “1.2345” valid {“2.3”,”4.5”,”1.2”- | |
| ”2.2”} ; | |
| DisplayString(6) cStr1 = “hello” valid { | |
| “hello”-”tata”,”hi”, “bye”}; | |
| IpAddress ipa valid {“1.2.3.4”- “2.3.4.5”, | |
| “100.200.300.400”}; | |
| }; | |
| AttributeType CompAttrA { | |
| Integer cal =9 valid {1,2,3, 7-15}; | |
| Double ca2 =“0.9” valid {“0.04”-”1.23”} ; | |
| DisplayString(4) ca3 = “lop” valid | |
| {“abc”,”bcd”,”lop”} ; | |
| Moid ca4 valid {“Integer.abc.12”}; | |
| }; | |
| AttributeType CompAttrB { | |
| Integer bInt2 = 2 valid {1-3}; | |
| sequence<Integer,4> bseqInt valid {11-33, 44, | |
| 55}; | |
| Moid bid3 = “Integer.abc.1” valid | |
| {“Integer.abc.1”, “Integer.bcd.12”}; | |
| }; | |
| AttributeType CompAttrB1 { | |
| Integer bInt_12 = 2 valid {1-3}; | |
| Float cfl valid {“1.2”-”3.4”} | |
| }; | |
| AttributeType CompAttrBcont { | |
| sequence<DisplayString,2> bseqdis valid {abc- | |
| xyz}; | |
| sequence<Moid,2> bseq_Int valid | |
| {“Integer.mn.100”}; | |
| CompAttrB contB; | |
| sequence<CompAttr,2> seqComp; | |
| }; | |
| AttributeType CompAttrC { | |
| Double c1 = “1.23” valid {“1.23”,”5.6”-”6.5”}; | |
| Integer c2 =1000; | |
| CompAttr C3 = {1,”1.2”,”hi”,”1.2.3.4”} valid | |
| {{1,”1.2”,”hi”,”1.2.3.4”}-{10,”5.4”,”mi”,”4.5.6.7”}}; | |
| }; | |
| AttributeType CompAttrD { | |
| Integer d1 =1; | |
| CompAttr d2; | |
| }; | |
| enum PafType { | |
| omni = 0, | |
| alpha = 1, | |
| beta = 2, | |
| gamma = 3, | |
| del_ta = 4, | |
| epsilon = 5, | |
| zeta = 6, | |
| none = 7 | |
| }; | |
| AttributeType CompAttrE { | |
| Integer ie; | |
| Float fe; | |
| DisplayString(4) stre = “jkl” valid {“abc”- | |
| ”111”}; | |
| Moid me; | |
| PafType ta = del_ta valid {gamma-zeta}; | |
| }; | |
| AttributeType CompAttrF { | |
| Float fff valid {“1.0”-”2.0”}; | |
| DisplayString(3) strf = “ab” valid {“ab”-”bc”}; | |
| CompAttrB fb = {3,”[11]”,”Integer.abc.1”}; | |
| } | |
| class test{ | |
| Integer testa; | |
| }; | |
| class testinherited extends test{ | |
| index { | |
| const Integer ViewTest = 1; | |
| Integer inherited; | |
| }; | |
| Integer inherita; | |
| }; | |
| class MoA { | |
| index { | |
| const Integer | ViewTest = 1; |
| Integer | Index1 ; |

| }; | |
|---|---|
| CompAttr compp; | |
| CompAttrA compA; | |
| CompAttrA compA2 valid | |
| {{1,”1.2”,”hhh”,”Integer.abc.1”}- | |
| {5,”1.4”,”mmm”,”Integer.bcd.12”}} | |
| ; | |
| CompAttrE compE = {1,”1.2”,”111”,”Integer.abc.1”}; | |
| CompAttrC compC1 = | |
| {“1.234”,12,{3,”3.5”,”as”,”1.2.3.4”}} valid | |
| {{“1.234”,12,{3,”3.5”,”as”,”1.2.3.4”}}}; | |
| CompAttrC compC2; | |
| CompAttrF compF = | |
| {“1.0”,”ab”,{3,”[2]”,”Integer.abc.1”}}; | |
| Integer a; | |
| Uint32 | param1 = 0; |
| Int | param2 = “−1” valid { “−1”, 1 - 10, 15 }; |
| Uint16 | param3 = 50 valid {0-200}; |
| Uint16 | param4; |
| Int | param5; |
| String | text; |
| String | text1 = “Hello” valid { “Hello”, “Goodbye” |
| }; | |
| Float | someFloat = “0.1” valid { “0.1” - “2.9” } |
| Ipaddr | addr; |

| CompAttrB1 cb1; | |
|---|---|
| }; | |
| class MoB { | |
| index { | |
| const Integer | ViewTest = 1; |
| Integer | Index2 ; |

| }; | |
|---|---|
| Int | parama; |
| Int | paramb; |
| Int | paramc; |

| DisplayString(4) str = “hel”; | |
|---|---|
| Int | parame = 5 valid {5-8}; |
| String | textb = “Hello” valid {“Bye”,”Hello”}; |
| Ipaddr | addr2 = “1233.45.67.8”; |
| Int | paramd; |

| CompAttrD compD; | |
|---|---|
| Moid dnid = “Integer.bdc.1” valid {“Integer.bdc.1”- | |
| ”Integer.bdc.2”} ; | |
| }; | |
| class MoC { | |
| index { | |
| const Integer | ViewTest = 1; |
| Integer | Index3 ; |
| }; | |

| | |
|---|---|
| Int | int1; |
| Int | int2; |
| String | textc; |
| Ipaddr | addr3; |
| PafType | someEnum = del_ta; |
| PafType | someEnum1; |

| sequence<Integer,5> cSeq valid {4,111-555, 6, 1000- | |
|---|---|
| 1003}; | |
| sequence<DisplayString,3> cSeq1 valid | |
| {“hello”,”hi”,”aaa”-”ccc”}; | |
| sequence<Moid,2> cSeq2 valid {“Integer.abc.12”- | |
| ”Integer.abc.14”, “Integer.abc.17”}; | |
| sequence<DistinguishedName,9> cSeq3 ; | |
| sequence<IpAddress,5> cSeq4 valid | |
| {“1.2.3.4”,”2.2.2.2”-”3.3.3.3”,”6.7.8.9”}; | |
| sequence<CompAttr,3> cSeq5; | |
| sequence<CompAttr,3> cSeq6 valid | |
| {{77,”52.234”,”xy”,”6.6.6.6”}- | |
| {92,”84.22”,”zy”,”9.9.9.9”},{8,”8.88”,”ei”,”8.8.8.8”}}; | |
| sequence<Uint16,10> cSeq7 valid {900-1000}; | |
| sequence<Float,10> cSeq8 valid {“1.24”,”9.87”}; | |
| sequence<PafType,10> cSeq9 valid {“del_ta”}; | |
| sequence<PafType,10> cSeq10 valid {“del_ta”-”none”}; | |
| sequence<PafType,10> cSeq11; | |
| Int trial = 1 valid {1,100,200,500}; | |
| IpAddress iap valid {“1.2.3.4”,”2.2.2.2”- | |
| ”3.3.3.3”,”6.7.8.9”}; | |
| Float fla = “1.23” valid {“0.09”-”1.34”}; | |
| CompAttr cCompAttr1 = {12,”1.234”,”he”,”1.2.3.4”} | |
| valid {{12,”1.234”,”he”,”1.2.3.4”}-{14,”2.22”, | |
| “me”,”3.1.1.1”}, {8,”8.88”,”ei”,”8.8.8.8”}}; | |
| /*CompAttrB compB11 valid | |
| {{3,”[2]”,”Integer.abc.1”}-{15,”[100]”,”Integer.abc.2”}}; | |
| CompAttrB compB12 valid | |
| {{11,”[11]”,”Integer.abc.11”}};*/ | |
| CompAttrB compB13; | |
| CompAttrBcont compBcont; | |
| }; | |
| class MoD { | |
| index { | |
| const Integer | ViewTest = 1; |
| Integer | Index3 ; |
| Integer | Index4 = 0 valid {“−10” - |

| “10”}; | |
|---|---|
| }; | |
| Int | d1; |
| Int | d2; |
| String | d3; |

| sequence<Uint32,11> dSeq1; | |
|---|---|
| sequence<PafType,3> dSeq2; | |
| sequence<Ipaddr,3> dSeq3; | |
| } | |
| class MoE { | |
| index { | |
| const Integer | ViewTest = 1; |
| Integer | Index3 ; |
| Integer | Index4 = 0 valid {“−10” - |
| “10”}; | |

| Integer IndexE = 1 valid {“1” - “5”}; | |
|---|---|
| }; | |
| Int | e1=99; |
| Float | e2=“1.0”; |
| } | |
| }; | |

Referring again to FIG. 9, the options file 46 is the customizing input file provided to MODL code generator 48 along with the parsed MODL file(s). The file provides customization of the generated MODL code and includes a sequence of commands separated by a semicolon. Each command has a unique name and a list of arguments. The option file 46 is typically named with a opt extension, but can be named. The file is typically passed to the MODL code generator with -o option. Other suitable arrangements to specify the options file may also be implemented.

The options file 46 permits and encourages reuse of code that was previously generated in the current code generation process. This also permits a set of reusable managed object definitions to be written separately on an MODL file. The code generated or modified (if necessary) can be made into a reusable library. The management application can make use of the reusable library without generating anything for the reusable MODL files/managed objects.

The various commands available to developers for customizing MODL code generation using in the options file 46 include: include-module, exclude-module, collection-mo-list, default-mo-list, root-dm-gen-flag, root-dm-class-name, generate-make-file-flag, make-file-name, compact-mo-gen-flag, row-status-flag, enforce-enum-flag, generate-root-classes-flag, mo-impl-name, and mo-impl-gen-flag.

The “include-module” command specifies a module name to be included. All the modules for which code is to be generated are included using an include-module command. If a given module is not included, sub-modules associated with that module are also not included for the code generation even if they are specified in the options file. The syntax for the include-module command is as shown below:
include-module <name of the module>;

The “exclude-module” command causes the MODL code generator to ignore all the classes defined in that particular module. The syntax for the exclude-module command is as shown below:
exclude-module <name of the module>;
   The “persistent-mo-list” and “collection-mo-list” commands are used to specify that the corresponding resource is to be made persistent. Persistent-mo followed by a list of managed object names tells the code generators to generate all the managed objects listed as persistent managed objects. For each class defined as persistent, a subclass of ManagedObject, PersObjectHandle, and ModlCollectionAdaptor are generated. This aspect of the option file also acts as an input to the database management code generator 50 (FIG. 6). The database management code generator takes the list of the persistent managed objects and generates the database schema (ddl) and tables.

When multiple managed objects are used with the persistent-mo-list or the collection-mo-list, managed objects higher in the hierarchy (i.e., parents) are usually mentioned first, followed by the related children. The persistent managed object values are stored in the database. If a server reboots, the managed objects can be loaded and the system state is retained. The syntax for the persistent-mo-list and collection-mo-list commands are shown below:
persistent-mo-list <name of mo1>, <name of mo2>..;
collection-mo-list <name of mo1>, <name of mo2>..;

The “default-mo-list” command is used to specify the managed objects that are not persistent (i.e., transient managed objects). These are dynamic managed objects and reside in main memory. The values for transient managed objects are lost if the server crashes or reboots. The syntax for the default-mo-list is shown below:
default-mo-list <name of mo1>, <name of mo2>...;

The “root-dm-gen-flag” command tells the MODL code generator to generate the RootDm class when set to true. This provides a convenient way of loading the managed objects from the database to the servers. By default, the flag is true. The syntax for the root-dm-gen-flag command is shown below:
root-dm-gen-flag <true/false>;

The “root-dm-class-name” command is used in conjunction with the root-dm-gen-flag. By default, the generated class name is RootDm. The root-dm-class-name command specifies another class name for the root dm class. The root dm class is used to load all persistent managed objects from the database in the data server. The syntax for the root-dm-class-name command is shown below:
root-dm-class-name <class name>;

The “generate-make-file-flag” command tells the MODL code generator to generate a makefile when set to true. By default, the flag is true. Developers can turn off generation of the makefile by setting the flag to false. The syntax for the generate-make-file-flag command is shown below:
generate-make-file-flag <true/false>;

The “make-file-name” command is used in conjunction with the generate-make-file-flag. By default, for example, the generated makefile name is “ModlGen.mk”. The make-file-name command specifies another name for the generated makefile. The syntax for the make-file-name command is shown below:
make-file-name <name of the file>;

The “compact-mo-gen-flag” command is deprecated if the MODL code generator generates compact managed objects by default. Otherwise, the compact-mo-gen-flag command is used to specify whether or not the MODL code generator is to generate compact managed objects.

The “row-status-flag” command indicates whether the system is being managed by SNMP. If set to true, the MODL code generator generates an additional Integer attribute for each persistent managed object associated with the amount of persistent data to be stored. The additional attribute is used to decide whether a given managed object can be created or deleted. By default, the flag is set to false. The syntax for the row-status-flag command is shown below:
row-status-flag <true/false>;

The “enforce-enum-flag” command is used in conjunction with enum definitions in the MODL files. When set to true, the flag tells the MODL code generator to generate a function called is EnumValid inside the Enum namespace. The generated method will also be called inside the generated classes when attempt to create or modify an enum attribute occur. By default, the flag is set to false. The syntax for the enforce-enum-flag command is shown below:
enforce-enum-flag <true/false>;

The “generate-root-classes-flag” command tells the MODL code generator to generate the classes corresponding to root module, such as “AttrDefns,” “MoDefns,” “EnumDefns,” “EnumAttrFactory,” as well as the root ddm, pmo adaptor class when set to true. The flag is true by default. The syntax for the generate-root-classes-flag command is shown below:
generate-root-classes-flag <true/false>;

The “mo-impl-name” command specifies the mo-impl name to be used for the given managed object. This may be useful when the implementation already exists. All that is needed is to generate the managed object to make use of the existing implementation. The syntax for the mo-impl-name command is shown below:
mo-impl-name <module.mo> <name of the Impl>;

The “mo-impl-gen-flag” specifies whether an implements class needs to be generated for a particular managed object. Implements classes are generated when a particular managed object had an action defined or when a developer specifies the mo-impl-name command for that managed object. When the flag is set to false, it is expected that a corresponding mo-impl-name command is also provided to specify the name of the implements class. The syntax for the mo-impl-gen-flag is provided below:
mo-impl-gen-flag <true/false>;

The command line options 44 are associated with a command to initiate the MODL code generation process. The command line options are arguments that may be specified in the command to customize the subsequent code generation. The syntax for the command and associated command line options is provided below:
modlGen -m odlFile [-c<collection mo list|“all”>] [-n <mo list|“all”>] [-g gen dir] [-r] -o opt file [ -d ddeGen dir]

The “m odlFile” command line option specifies the file name that contains the MODL specification for the given network element. The -m command line option is, for example, a mandatory argument. Multiple MODL files can be specified using multiple -m options in the command line. The “c collection mo list” command line option is a list of fully qualified collection-managed object names that are specified in the MODL files and separated by commas. For example, -c C2k.BscCfg, C2k.BurstControl.

The “n mo list” command line option is a list of fully qualified managed object names that are specified in the MODL files and separated by commas. For example, -i C2k.BscCfg, C2k.BurstControl. For these exemplary managed objects, managed object implementations are generated and the generated managed object is self-contained. The “g gen dir” command line option specifies the directory where the output file is generated.

The “o opt file” command line option specifies the code generation option file that is used by the code generator during code generation.

The “d ddeGen dir” command line option specifies the directory where the automatically generated input file (DdeGen.ads) for the DDE Application Data Specification (ADS) tool will be generated. The DDE ADS tool uses the input file to generate code for data range checking.

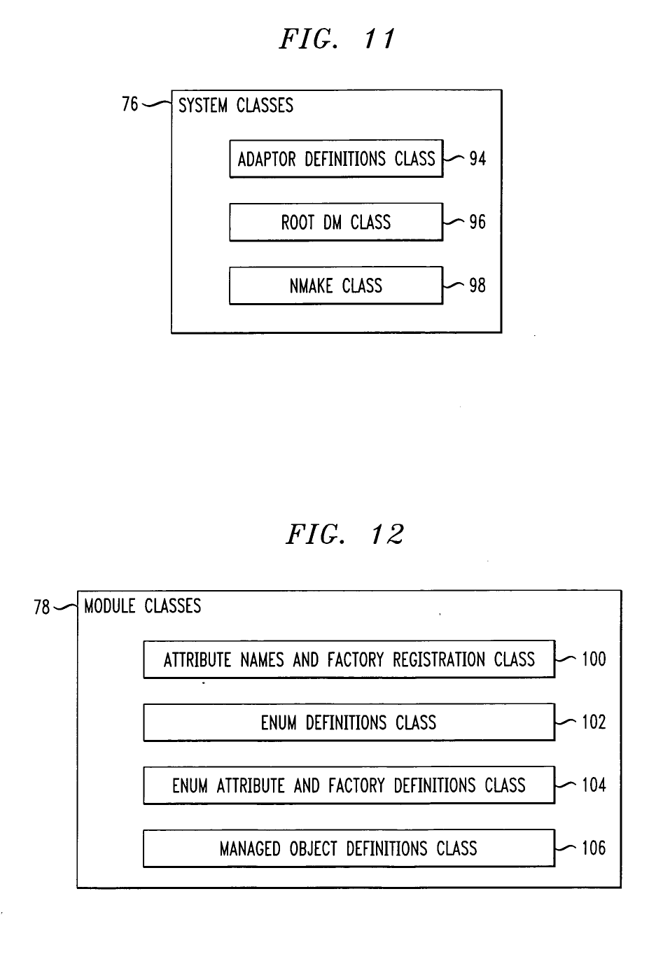

With reference to FIG. 11, an embodiment of system classes 76 of MODL code includes an adaptor definitions class 94, a RootDm class 96, and an Nmake class 98. Each of the system classes 76 are generated on a per system basis with respect to the managed system design. The adaptor definitions class 94 is typically generated as PersAdaptorDefns.h and PersAdaptorDefns.c files. The RootDm class 96 is typically generated as RootDm.h and RootDm.c files. The Nmake class 98 is typically generated as a modlGen.mk file. Other suitable file names are contemplated. For example, user-specified file names are permitted.

The adaptor definitions class 94 defines the new managed object adaptor type for the persistent managed object. It also instantiates all the adaptors during run time. This is mainly used in the data server. The RootDm class 96 loads all the managed object instances starting from the root of the management tree down to the leaf nodes to load all the persistent managed object instances for the entire system.

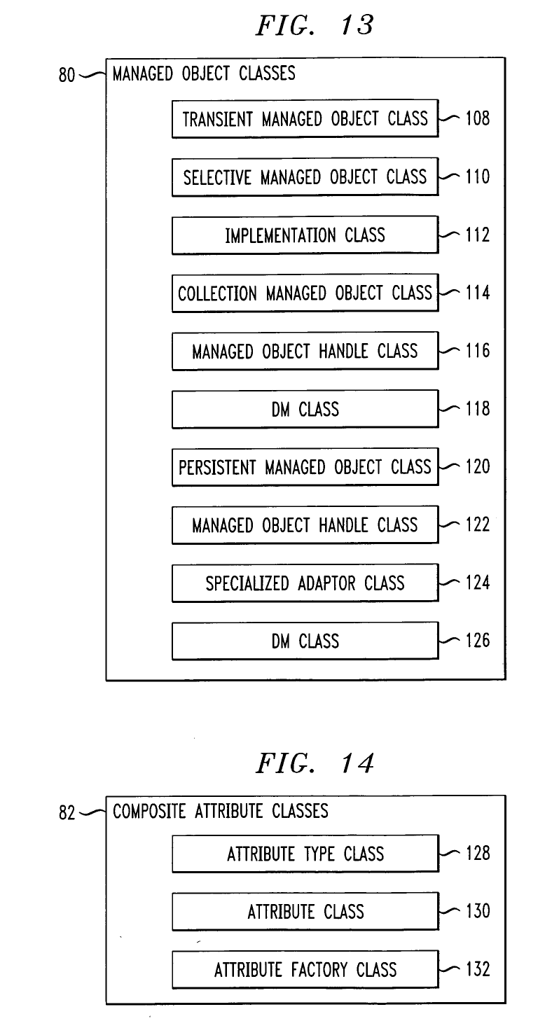

With reference to FIG. 12, an embodiment of module classes 78 of MODL code includes an attribute names and factory registration class 100, an enum definitions class 102, an enum attribute and factory definitions class 104, and a managed object definitions class 106. Each of the module classes 78 are generated on a per module basis with respect to the managed system design. Each attribute names and factory registration class 100 is typically generated as <<prefix>>AttrDefns.h and <<prefix>>AttrDefns.c files. Each enum definitions class 102 is typically generated as <<prefix>>Enum.h and <<prefix>>Enum.c files. Each enum attribute and factory definitions class 104 is typically generated as <<prefix>>EnumAttrFactory.h and <<prefix>>EnumAttrFactory.c files. Other suitable file names are contemplated. For example, user-specified file names are permitted.

The attribute names and factory registration class 100 contains the list of names for attributes and methods to register the factory definitions of the individual managed objects. This includes method “static void registerAttributeFactories(void)” which registers the definitions of attribute factories with the AttributeFactoryFinder for each attribute of managed objects in the system. The attribute names and factory registration class 100 also includes a nested class for each managed object class. The nested class includes attribute definitions for that managed object. The nested class also includes method “static void registerAttributeFactories(void)” to register the definitions of attribute factories with the AttributeFactoryFinder for that managed object and another method “static const char* getFullClassName(void)” to return the fully qualified class name of the managed object class. This nested class registerAttributeFactories is recommended for servers that manage a limited number of managed objects.

The enum definitions class 102 provides C++ declarations corresponding to the enum defined in the MODL files. The enum attribute and factory definitions class 104 defines the new type for each enum entry in the MODL files that include EnumAttribute parameterized with that enum type that would be used as an attribute of the managed object. The enum attribute and factory definitions class 104 also generates the type name for the enum. This is essentially a template class that is intended to be user friendly.

The managed object definitions class 106 includes the schema of the managed objects. For example, managed object definitions class 106 includes method “static void createManagedObjectDefs(void)” that creates and registers definitions for managed objects in a given module. This also calls “createManagedObjectDefs” for sub modules. The managed object definitions class 106 also includes a nested class for each managed object class. The nested class includes the attribute definitions for that managed object and method “static void createManagedObjectDefs (void)” to register the definitions of the managed objects and its attributes.

With reference to FIG. 13, an embodiment of managed object classes 80 of MODL code includes a transient managed object class 108, a selective managed object class 110, an implementation class 112 (associated with the selective managed object class), a collection managed object class 114, a managed object handle class 116 (associated with the collection managed object class), a Dm class 118 (associated with the collection managed object class), a persistent managed object class 120, a managed object handle class 122 (associated with the persistent managed object class), a specialized adaptor class 124 (associated with the persistent managed object class), and a Dm class 126 (associated with the persistent managed object class). Each of the managed object classes 80 are generated on a per managed object basis with respect to the managed system design. Either a transient managed object class 108, selective managed object class 110, collection managed object class 114, or persistent managed object class 120 is generated for each managed object. Each managed object class is typically generated as <<prefix>><<managed object class name>>MO.h and <<prefix>><<managed object class name>>MO.c files. Other suitable file names are contemplated. For example, user-specified file names are permitted.

An implementation class 112 is generated for each selective managed object class 110. Each implementation class 112 is typically generated as <<prefix>><<managed object class name>>Impl.h and <<prefix>><<managed object class name>>Impl.c files. A managed object handle class 116 is generated for each collection managed object class 114 and each persistent managed object class 120. Each managed object handle class 116, 122 is typically generated as <<prefix>><<managed object class name>>MOHandle.h and <<prefix>><<managed object class name>>MOHandle.c files. A Dm class 118, 126 is generated for each collection managed object class 114 and each persistent managed object class 120. Each managed Dm class 118, 126 is typically generated as <<prefix>><<managed object class name>>Dm.h and <<prefix>><<managed object class name>>Dm.c files. A specialized adaptor class 124 is generated for each persistent managed object class 120. Each specialized adaptor class 124 is typically generated as <<prefix>><<managed object class name>>Adaptor.h and <<prefix>><<managed object class name>>Adaptor.c files. Other suitable file names are contemplated. For example, user-specified file names are permitted.

The transient managed object class 108 is the simplest form of managed object. This type of managed object includes self-contained attributes and provides access to the attributes using the access functions. The transient managed object class 108 includes a default constructor that adds the attributes to the managed object. The default constructor optionally includes a flag, typically referred to as baseMoFlag, that signifies whether the managed object is directly instantiated or if it is instantiated by its derived class. The transient managed object class 108 also includes accessor method for the index and accessor and modifier methods for the attributes. Additionally, method “static void registerOnCreate(int flag)” is generated for the transient managed object class 108. When this flag is set, the managed object is registered with the name server when it is created.

The transient managed object class 108 includes method “const char* objectType( ) const.” This method returns the name of the managed object specified in the MODL file and is needed by the StreamableObject. The transient managed object class 108 also includes method “void setDn(DistinguishedName& dn).” This method assigns the distinguished name to the managed object instance and registers the managed object instance with the name server if “registerOnCreateFlag_” is set. The class also include method “static const char* getManagedObjectClassName(void).” This method returns the name of the managed object.

The transient managed object class 108 includes method “static void getDefaultDn(DistinguishedName& dn)” to get the default distinguished name of the given managed object class. The class also includes an equality operator to check whether two managed objects are equal. Two managed objects are equal if the distinguished names for both are the same. If the managed object contains action, then dispatch( ) method is generated for the transient managed object class 108. This method performs the actual dispatching of the action targeted at the managed object. The transient managed object class 108 also includes checkAttribute and checkDn methods for simple range checks for both the index and the attribute. If the class definition contains attributes having ranges, the checkAttribute and checkDn method have the necessary range check code, otherwise the class returns success.

The selective managed object class 110 delegates the operation on the managed object to an implementation class. In other words, a selective managed object is a transient managed object that delegate managed object operations to an implementation class. The code generator generates both the managed object implementation as well as the delegated class implementation. The developer can take the delegated class implementation and add the implementation code specific to the managed system. If the delegated class implementation is already available to the developer, the developer modifies both of these generated classes or rewrites both classes. This is an exception where the generated class is modified by the developer. A class that delegates to a delegated class cannot be made persistent.

The selective managed object class 110 includes a default constructor that adds the attributes to the managed object. This method internally creates the actual implementation class on which it actually delegates. The constructor includes a pointer to the actual implementation class. For example, MemberFnPtrAttribute, CompositeMemberFnPtrAttribute, or EnumFnPtrAttribute are generated for the selective managed object class 110.

The selective managed object class 110 also includes method “static void registerAttributeFactories(void).” This method registers the attribute names and the corresponding factory with the class AttributeFactoryFinder. A specialized factory, such as MemberFnPtrAttributeFactory, EnumFnPtrAttributeFactory, or CompositeMemberFnPtrAttributeFactory, is installed in the case of delegation managed objects. This factory need not be installed in the address space of the agent server, because the implementation class is typically not exposed to the agent server. The agent server, for example, uses the IntegerAttributeFactory for the same attribute while the managed object server, for example, uses MemberFnPtrAttributeFactory<int,..> for the same attribute. If the MemberFnPtrAttributeFactory is used in the agent server address space, the selective managed object is linked with the agent server. If the selective managed object includes action, the dispatch( ) method is generated. This method performs the actual dispatching of the action targeted at the selective managed object.

The implementation class 112 is generated for the selective managed objects (i.e., transient managed objects that delegate managed object operations to an implementation class). There is one implementation class for each selective managed object. The developer may modify these classes to perform application specific actions. However, these classes can also be used without modification or with minimal modification. For example, out of ten attributes, if the developer is only interested in handling one attribute, the developer modifies either accessor or modifier or both methods of that attribute and the rest of the attributes are unaffected.

Generation of the implementation class is useful when there is no existing code available and the application is written from scratch. If legacy implementation classes are available, the implementation class is not useful to the developer. In such cases, the developer typically modifies the managed object as well. The generated implementation class includes native variables for the attributes. For example, the generated class may include a member of type int for the IntegerAttribute. The generated implementation class also includes accessor methods for the attributes. If the selective managed object contains any action signatures, action is generated for each signature.

The persistent managed object class 120 is more efficient than the collection managed object class 114. The persistent managed object implementations are stored individually in the database. There is no relation between two instances of persistent managed objects. In order to load persistent managed objects, the application process uses their id. For example, the valid range of persistent managed object mo1 may be 0 to 6. Then, seven instances of mo1 could be loaded individually starting from sector id 0 and proceeding to sector id 6. The files generated by the MODL code generator for transient managed object classes 108 are also generated for persistent managed object classes 120. The code generator also generates the handle constructor for persistent managed objects. The handle constructor provides the address where the persistent managed object is stored in the database and initializes the attributes to directly reference the database memory for the persistent managed object.

The persistent managed object class 120 includes method “static size_t getPersistentStorageSize(void).” This method returns the size occupied by the persistent managed object in the database. The class also includes method “static <MO>* create(Database* db, const DistinguishedName& dn).”<MO> is the name of the managed object class. This method creates each instance of the managed object. The attributes of the managed object directly reference the database memory. Modification of the attribute is directly reflected in the database. If the managed object contains action, dispatch( ) method is generated. This method performs the actual dispatching of the action targeted at the managed object. The persistent managed object class 120 also includes an equality operator. The class further includes externalize and internalize methods to save and restore.

The managed object handle class 116 is generated for persistent managed objects. The handle class is derived from the class PersObjectHandle. Developers may use this class directly. The handle class provides methods for directly accessing the data from database for RAC management framework classes.

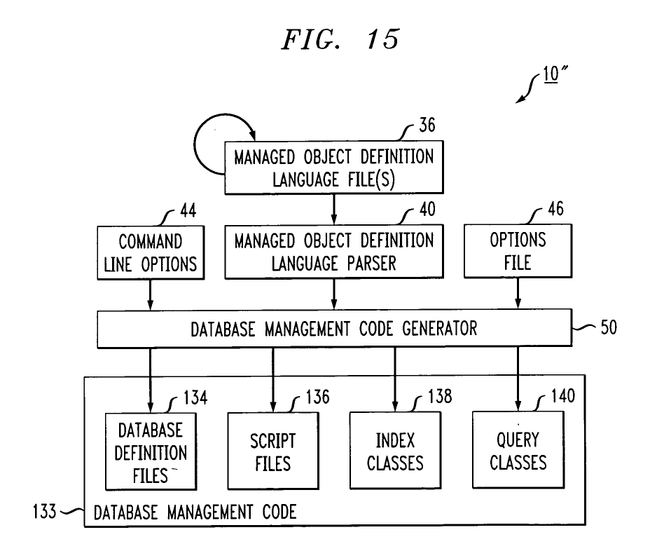

With reference to FIG. 14, an embodiment of composite attribute classes 82 of MODL code includes an attribute type class 128, an attribute class 130, and an attribute factory class 132. Each of the composite attribute classes 82 are generated on a per composite attribute basis with respect to the managed system design. Each attribute type class 128 is typically generated as <<prefix>><<attribute name>>.h and <<prefix>><<attribute name>>.c files. Each attribute class 130 is typically generated as <<prefix>><<attribute name>>Attribute.h and <<prefix>><<attribute name>>Attribute.c files. Each attribute factory class 132 is typically generated as <<prefix>><<attribute name>>AttributeFactory.h and <<prefix>><<attribute name>>AttributeFactory.c files. Other suitable file names are contemplated. For example, user-specified file names are permitted.

The attribute type class 128 includes a handle class that is the memory representation of the attribute in the database. The handle class includes variable declarations for the attributes within the composite attribute. The handle class also includes method “int compare(const ConnectionIdHandle& key) const.” This method compares two handle objects and returns 0 when they are equal, 1 when the given object is greater than the key, and −1 when the given object is less than the key. The handle class further includes comparison operators, such as operator ==, operator !=, operator <, and operator >.

The attribute type class 128 also includes a class representing the composite attribute that is a wrapper over the handle class. The wrapper class is derived from the StreamableObject and is capable of streaming itself to ObjectStream. This class includes a default constructor and a reference handle constructor that references a handle that may be in the memory mapped database. Any modification to the current class is reflected on this handle and passed as a parameter. The wrapper class also includes a handle value constructor that copies the value from the handle. The wrapper class further includes accessor and modifier methods for the attributes in the given composite attribute, a compare method, and externalize and internalize methods to stream in and out of ObjectStream. This class also includes comparison operators, such as operator ==, operator !=, operator <, and operator >. The wrapper class includes method “static size_t getPersistentStorageSize(void)” to return the size of the attribute in the persistent storage. The class also includes set and get Components( ) method with individual elements. This method is used to set and get the individual elements.

The attribute class 130 is derived from Attribute and represents the composite attribute class that can be contained by the ManagedObject directly. This class is a wrapper over the Attribute type class described above. The attribute class includes a default constructor and a reference handle constructor that references a handle. The handle may be in the memory mapped database. Any modification to the attribute class are reflected on this handle and passed as a parameter. The handle value constructor copies the value from the handle. The attribute class includes accessor and modifier methods for all the attributes in the given composite attribute. The attribute class also includes overloaded method “value” to return the handle and set the value from the handle.

The attribute class further includes method “const char* objectType(void) const.” This method returns the type of the attribute defined in the MODL file. The attribute class also includes externalize and internalize methods to stream in and out of ObjectStream. The attribute class further includes compare method and comparison operators, such as operator ==, operator !=, operator <, and operator >. The attribute class also includes method “static size_t getPersistentStorageSize(void).” This method returns the size of the attribute in the persistent storage. The attribute class further includes a virtual constructor and “create” method. The attribute class also includes overridden method “copyFrom” of the base class Attribute to copy the contents of one attribute to another. The attribute class further includes overridden method “compare” of the base class Attribute to check whether the two attributes are equal.

The attribute factory class 132 is generated for every composite attribute declared in the MODL files. This class is derived from AttributeFactory and creates an attribute of the given composite attribute type.

Referring again to FIG. 9, the MODL code generator may optionally include a data design environment generator (DdeGen). DdeGen provides support for persistent managed objects and PF in the area of data constraint checking. The DdeGen automatically generates input file (DdeGen.ads) for the DDE Application Data Specification (ADS) tool and code for data range checking. The generated code is executed at run time on the context of a commercial database management process, such as DataBlitz, developed by Lucent Technologies and currently outsourced to Mascon Technologies. The agent server is not required to do the range checking, except for specific data types associated with the RAC management framework. As an option, client network management applications may use DdeGen database trigger code so that additional constraints may be manually added by developers without requiring the agent server for most constraints checking.

The scope of DdeGen is to integrate client network management applications with DDE to provide range check functionality. Specific data types and range checks associated with the RAC management framework are not supported by DDE. Examples of the data types for which the RAC management framework support range checks instead of DDE are identified below:
DistinguishedName
CompositeAttribute
DisplayString (or String in *.odl)
Sequence

For the above specific data types associated with the RAC management framework, DdeGen uses the MODL code generator to generate range checks for client network management applications. For the DisplayString and String data types, DdeGen generates domain definitions in the DdeGen.ads file if the corresponding valid cluster only contains discrete values.

The MODL and database management code generators may be used with DDE using DdeGen. For example, development of network management applications can perform the following steps: 1) run the MODL code generator to generate code with an option specifying that DDE will also be used to generate code, 2) run the DDE tool to generate code, 3) run the database management code generator, 4) compile the DDE generated code into a first trigger library for DDE triggers, 5) build the network management applications with an option specifying a second trigger library for RAC management framework triggers generated by DdeGen, 6) copy the first and second trigger libraries to a directory accessible to the database management system software, 7) install the second trigger library (RAC management framework triggers) in the database management system software for constraint checking, 8) install the first trigger library (DDE triggers) in the database management system software application for constraint checking, and 9) run network management application. The database management system software application may be a commercial application, such as DataBlitz, developed by Lucent Technologies and currently outsourced to Mascon Technologies.

With the agent server operational, network management applications install triggers generated by both the DDE and RAC management framework. Under these circumstances, data constraints corresponding to the DDE and RAC management framework triggers are checked. With the agent server down, network management applications install triggers generated by the DDE. Under these circumstances, data constraints corresponding to the DDE triggers are checked.

With reference to FIG. 15, an embodiment of a RAC development environment 10″ for generating database management code includes the MODL file(s) 36, MODL parser 40, command line options 44, options file 46, database management code generator 50, and database management code 133. The database management code 133 includes database definition files 134, script files 136, index classes 138, and query classes 140. As described above in reference to FIGS. 1, 3, and 10, the MODL file(s) 36 are prepared and provided to the MODL parser 40. The MODL parser 40 parses the file(s) and provides object meta-data to the database management code generator 50 as described above in reference to FIGS. 1 and 4. If implemented, the options file 46 is prepared and provided to the database management code generator 50 as described above in reference to FIGS. 1, 5, and 9. A command to initiate the database management code generator 50 is entered with selected command line options 44 and executed as described above in reference to FIGS. 1, 5, and 9. The database management code generator 50 generates database definition files 134, script files 136, index classes 138, and query classes 140 as described above in reference to FIGS. 1 and 6.

The database management code generator 50 may, for example, be a Java-based generation tool. The database management code generator 50 generates the database management code 133 based on the content of the MODL file(s) 36 and in accordance with commands and arguments (i.e., instructions) in the command line options 44 and the options file 46. More specifically, the database management code generator 50 generates the data definitions and trigger definitions for database schema (i.e., database definition files 134) and a set of classes that contain capture data indices (i.e., index classes) and queries information (i.e., query classes 140) based on the managed object definitions given in the MODL file(s) 36. In one embodiment, the index and query classes may be C++ classes. The database management code generator 50 also generates shell scripts (i.e., script files 136) to help applications create the database. In one embodiment, the script files 136 may be Unix shell scripts.

As discussed above, the command line options 44 are associated with a command to initiate the database management code generation process. The command line options 44 are arguments that may be specified in the command to customize the subsequent code generation. The syntax for the command and associated command line options is provided below:
DbGen -m “MODL file” -o “option file” [-t “trigger method”] [-g generation dir] [-l]

The “m ‘MODL file’” command line option defines the MODL files and corresponding managed objects for which code is to be generated. The database management code generator 50 uses these files to get the data definitions for generating the database schema.

The “o ‘option file’” command line option, for example, defines the managed objects that need persistence storage in the database. The database management code generator 50, for example, processes the following options in the options file 46: 1) persistent-mo-list, 2) collection-mo-list, 3) row-status-flag, and 4) schema <schema name><database id>. The “persistent-mo-list” and “collection-mo-list” options causes the database management code generator 50 to generate data definitions for the persistent managed objects specified in the corresponding list. If the flag is set to true, the “row-status-flag” option causes the database management code generator 50 to generate a row number as one of the data items in the data definitions for the persistent managed objects. The “schema <schema name><database id>” option causes the database management code generator 50 to generate schema associated with information in database scripts (e.g., dbInstall.sh and runRelddl.sh) that can be used to create the schema in the database

The “t ‘trigger method’” command line option specifies a <trigger function name> and causes the database management code generator 50 to generate the trigger definition that registers the function to be called whenever the database is updated. The “g generation dir” command line option specifies a <generation directory name> where the generated index and query classes 136, 140 are to be stored. The “1” command line option specifies whether the database management code generator 50 should permit generation of data definitions for strings that are larger than 2000 characters. By default, the database management code generator 50 does not accept strings for data definitions that are larger than 2000 characters and identifies an error if this option is not specified.

The output files generated by the database management code generator 50 include three categories: 1) data definition files for database schema, 2) script files for creating schema in the database, and 3) classes for database indices and queries. The data definition files include, for example, DbGen.ddI and Trigger.ddI. The script files include, for example, dbInstall.sh and runRelddel.sh. The classes may be C++ classes and include the index classes 138 and query classes 140.

In one embodiment, the network management application is used in conjunction with a commercial database management system software application, such as DataBlitz, developed by Lucent Technologies and currently outsourced to Mascon Technologies. If DataBlitz, for example, is used, the data definition files 134 use Data Definition Language (DDL) to define database tables and indices based on the managed objects definitions in the MODL file(s) 36. DDL is similar like standard query language (SQL). DbGen.ddI, for example, can be used by the network management application to populate the schema in the database.

The table below shows how MODL terminologies in the MODL file(s) 36 are mapped to DDL keywords in the DDL file.

| MODL Term | DDL Key word | Notes |
|---|---|---|
| Module and class | Table | tableName = moduleName + |
| | | className |
| index | Primary hash | IndexName = tableName + 1 |
| | index | Index column = index item in |
| | | Modl |
| Simple attribute | Column | columnName = attributeName |
| Composite attribute | Multiple columns | ColumnName = |
| | | attributeName_itemName |

The table below shows how data types are mapped between MODL and DDL files.

| MODL data type | DDL data type | Notes |
|---|---|---|
| Integer, Int, Uint16, | INTEGER | |
| Uint32, enum | | |
| Float | FLOAT | |
| Double | DOUBLE | |
| String, DisplayString | CHAR(length) | If length is defined in |
| | | MODL, then DDL char |
| | | column will use the same |
| | | length, otherwise length = 128. |
| | | The up limit of length is 2000, |
| | | except “−1” option used |
| Ipaddr | INTEGER | |
| DistinguishedName, | CHAR(512) | |
| Moid | | |
| Sequence | VARBINARY | Variable length binary |
| OctetString | BINARY(132) | |

The exemplary code listed below is an example of a section from an MODL file 36 (e.g., uc.odl), a section from an options file 46 (e.g., uc.opt), and a section of corresponding DDL code in a database definition file 134 (e.g., DbGen.ddI) generated by the database management code generator 50.

Inuc.odl file:

| module UC { | |
|---|---|
| AttributeType House { | |
| Integer room = 0; | |
| DisplayString(32) building; | |
| }; | |
| enum Term { | |
| fall = 1, | |
| winter = 2, | |
| sprint = 3, | |
| summer = 4 | |
| }; | |
| class Student { | |
| index { | |
| Integer ssn; | |
| }; | |
| Int | studentId = 0 valid { 0 - 10000 }; |
| String | name; |
| Term | quarter; |
| Float | fee = “0” valid { “0” - “3000.00” } |
| Ipaddr | networkHost; |
| House | dorm; |

```
        sequence<Integer,5> courseIds;
    };
};
```

In uc.opt file:

schema UC 11;
collection-mo-list UC.Student;
row-status-flag true;

In the DbGen.ddI file generated by the database management code generator:

| | |
|---|---|
| CREATE TABLE “UCStudent” | ( |
| “ssn” | INTEGER NOT NULL, |
| “studentId” | INTEGER DEFAULT 0, |
| “name” | CHAR(128) DEFAULT ‘’, |
| “quarter” | INTEGER DEFAULT 1, |
| “fee” | FLOAT DEFAULT 0.0, |
| “networkHost” | INTEGER DEFAULT 0, |
| “dorm_room” | INTEGER DEFAULT 0, |

“dorm_building” CHAR(32) DEFAULT ‘’,

| | |
|---|---|
| “courseIds” | VARBINARY, |
| “RowStatus” | INTEGER DEFAULT 0 |
| ); | |

CREATE PRIMARY HASH INDEX “UCStudent1” ON “UCStudent”
(“ssn”);

Note that the schema information defined in the uc.opt file is shown in the script files 136 discussed below, not the database definition file 134 above.

Another database definition file (e.g., trigger.ddl) generated by the database management code generator 50 contains trigger definitions described in DDL. The trigger definitions in trigger.ddl can be used by the network management application to register the trigger function for every table. Then, the trigger function will be called whenever data is changed in the database. A section of DDL code in trigger.ddl corresponding to the exemplary code above for uc.odl, uc.opt, and DbGen.ddl is provided below. In the above trigger.ddl example, the trigger is named with the format: <moduleName><className>T. The procedure handleBlzTrigger is the function name given by option “-t triggerName” when the database management code generator 50 was invoked.
CREATE TRIGGER “UCStudentT” ON “UCStudent” AFTER UPDATE OR INSERT OR DELETE PROCEDURE “handleBlzTrigger” PRIORITY 5;

The database management code generator also generates a script file 136 (e.g., runRelddl.sh) to invoke DataBlitz command line tool relddl with an input file list. An example of the runRelddl.sh script file is shown below. The relddl-input-files are files that contain relddl commands, such as table creation command, trigger creation command, etc. The generated script file runRelddl.sh contains schema and password information that is required by DataBlitz. Note that the schema name is defined in the uc.opt file. If a schema name is not defined in a *.opt file, the default schema name “datablitz” and the default password is “datablitz.”
runRelddl.sh <relddl-input- files>

The block of code below highlights what is accomplished by the runRelddl.sh script file:

```
for i
do
    if [ -f $i ]
    then
        cat $i | $BLZ_ROOT/bin/relddl -u UC -p ““
done
```

The database management code generator also generates another script file 136 (e.g., dbInstall.sh) to create schema in the database. An example of the dbInstall.sh script file is shown below. If a schema name other than “datablitz” is defined in the options file 46, dbInstall.sh creates a schema in the database with the given name and sets the password for this schema as an empty string. If there is no schema name defined in the options file 46, dbInstall.sh uses the default schema “datablitz.” dbInstall.sh uses DbGen.ddI and Trigger.ddl (if “-t” passed to the script) for data definitions in the schema. The dbInstall.sh is located in the same directory as DbGen.ddl and Trigger.ddl when it runs. If an input file list is provided to this script it will invoke runRelddl.sh to run for the files in the list.
dbInstall.sh [-t for install RAC trigger] [-h for help] [input file list]

The block of code below highlights what is accomplished by the dbInstall.sh script file:

# create schema in the database
$BLZ_ROOT/bin/blzschema -u blzdba -p blzdba -S UC -P ““ -
i 11
# create tables and indices
echo Create tables and indices ...
$bindir/runRelddl.sh $bindir/DbGen.ddl
# create RAC generated trigger if “-t” option
if [ “$trigOpt” = “yes” ]
then
$bindir/runRelddl.sh $bindir/Trigger.ddl
fi

For each class defined in the MODL file(s) 36 and listed in a “collection-mo-list” command of the options file 46, the database management code generator 50 generates classes that contain the information of the index representation of the corresponding table in the database. For example, for class “Student” in the exemplary sections of an MODL file and an option file shown above, classes UCStudentDbIndexHandle and UCStudentDbIndex are generated in a C++ file. The pertinent section of the C++ file is shown below. The generated index classes are used by PF to access data in the database.

```
class UCStudentDbIndexHandle {
public:
  int ssn_;
};
class UCStudentDbIndex : public DbIndex {
    ...
  UCStudentDbIndexHandle* handle_;
}
```

With DataBlitz, for example, a query object can be built in advance and used again and again. For each class defined in the MODL file(s) 36 and listed in a “collection-mo-list” command of the options file 46, the database management code generator generates a class that sets the reusable and optimized database query for the corresponding table in the database. For example, for class “Student” in the exemplary sections of an MODL file and an option file shown above, class UCStudentDbQuery is generated in a C++ file. The pertinent section of the C++ file is shown below.

class UCStudentDbQuery : public DbQuery
{
...
void populateQueryOnTable( DbTable* table );
};

Initially a query object is made to refer to DB index object. Whenever the content of DB index object is modified, the query object is automatically modified and there is no need to construct the query again. Subsequently, when the database is accessed, the constructed query object can be readily used, thus improving performance of queries. The generated query classes are used by PF to access data in the database. The database management code generator also generates class QueryInitializer which may be used to initialize the database query objects for the managed objects defined in the MODL file(s) 36.

In summary, the following is an example of how to generate code for a network management application that would be installed in an agent server. It is intended for the server network management application to manage persistent managed objects. The following steps are performed by the developer: 1) define the MODL file, 2) define the option file, and 3) run the code generator.

MODL is used to define the managed object, its index, and the attributes it contains in the MODL file. MODL file serves as the basis for code generation. An exemplary MODL file declaration is provided below:

| # MODL File th.odl | |
|---|---|
| module TH { | |
| class Simple { | |
| index { | |
| const Integer | TH = 1; |
| Integer | Simple valid {1-10}; |
| }; | |
| Integer value; | |
| DisplayString(64) | text=“Hello, world”; |
| }; | |
| }; | |

In the above example, class Simple is defined under the module TH (i.e., Test Harness). The module in MODL is simply a name space that serves as a container for names. The index of this managed object is Simple and the managed object includes some attributes. The attribute type DisplayString specifies the null terminated string. If no size is provided, the default size of 128 is implied for the DisplayString attribute. The default value for the DisplayString attribute text is specified as “Hello, world.” If a managed object is created and text is not otherwise specified, the managed object will be initialized with “Hello, world.”

The RAC development environment permits developers to use an options file rather than using the command line. This is convenient because there are a variety of different options associated with code generation and there may be hundreds of options associated with a given network or system. An exemplary options file is provided below:
# Options file “th.opt”
collection-mo-list TH.Simple;
include-module TH;

In the above example, the managed object Simple is specified under the module TH and identified as collection managed object. Collection managed object are persistent, kept in the database, and are accessible through MOF. The fully qualified managed object name is being used when the modules name is followed by a period and the managed object name. Here, TH.Simple is a fully qualified managed object name. The “include-module” command specifies that the TH module should be included in the code generation. Without an include command, nothing would be generated for any declarations defined under the module.

The code generator, for example, may be a shell script (e.g., ModlGen in $RACTOOLSHOME/bin) that makes use of Java jar files. In other words, the code generator may be written in Java and run using Java virtual machine. In the example being explained, the MODL file name is “th.odl”, and option file name is “th.opt.” Thus, the code generator is run using the following exemplary command and command line options:
$ ModlGen -m th.odl -o th.opt

The code generator accepts multiple MODL files and multiple options files. In the example being explained, the code generator generates the C++ class files in the current directory.

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

1. A method of defining a distributed system to facilitate development of an application program to manage the distributed system, the method including the steps:
a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system;
b) parsing the one or more resource definition language files to ensure conformity with the object-oriented resource definition language and creating an intermediate representation of the distributed system from the one or more conforming resource definition language files; and
c) processing the intermediate representation of the distributed system to form one or more programming language classes, one or more database definition files, and one or more script files.

2. The method as set forth in claim 1 wherein the distributed system is a network.

3. The method as set forth in claim 2 wherein the network is a telecommunication network.

4. The method as set forth in claim 1 wherein the one or more managed objects includes a first managed object and one or more other managed objects are defined as an implementation of the first managed object.

5. The method as set forth in claim 4 wherein the first managed object does not exist in the hierarchical structure of the distributed system.

6. The method as set forth in claim 5 wherein the first managed object acts as an external proxy interface with respect to the distributed system.

7. The method as set forth in claim 1 wherein at least a first managed object is defined and a second managed object is defined to inherit the first managed object.

8. The method as set forth in claim 7 wherein at least a third managed object is defined to inherit the second managed object, thereby also inheriting the first managed object.

9. The method as set forth in claim 1 wherein the one or more managed objects includes a first managed object, a second managed object, and a third managed object, wherein the third managed objects is defined as an implementation of the first managed object and is also defined to inherit the second managed object.

10. The method as set forth in claim 1 wherein at least a first managed object is defined and a second managed object is defined as a child of the first managed object.

11. The method as set forth in claim 10 wherein a third managed object is defined as a child of the second managed object and as a child of the first managed object.

12. The method as set forth in claim 1 wherein the one or more resource definition language files are prepared in accordance with the object-oriented resource definition language and include a module declaration.

13. The method as set forth in claim 12 wherein the module declaration in each of the one or more resource definition language files includes at least one of an attribute type definition declaration, an enum type definition declaration, a managed object class declaration, and another module declaration.

14. The method as set forth in claim 13 wherein at least one of the one or more resource definition language files includes a module declaration and a managed object class declaration, the managed object class declaration further including an index specification and an attribute declaration.

15. The method as set forth in claim 1 wherein the resource definition language reserves at least one of a “module” keyword, a “class” keyword, an “AttributeType” keyword, an “index” keyword, a “const” keyword, a “Valid” keyword, a “readonly” keyword, an “extends” keyword, an “implements” keyword, an “enum” keyword, an “action” keyword, an “in” keyword, and an “out” keyword.

16. The method as set forth in claim 1 wherein the resource definition language reserves an “index” keyword and an “index” declaration specifies one or more attribute declaration, wherein the one or more attribute declarations include at least one attribute declaration that specifies a child relationship from an associated managed object to another managed object.

17. The method as set forth in claim 1 wherein the resource definition language reserves an “extends” keyword and an “extends” declaration is associated with a first managed object and specifies another managed object that is inherited by the first managed object.

18. The method as set forth in claim 1 wherein the resource definition language reserves an “implements” keyword and an “implements” declaration is associated with a first managed object and specifies another managed object of which the first managed object is an implementation.

19. The method as set forth in claim 1, further including the step:
d) defining an options file with one or more commands for customizing operation of the processing step, wherein the processing is subsequently performed in accordance with the one or more commands in the options file.

20. The method as set forth in claim 19 wherein the options file includes at least one of an “include-module” command, an “exclude-module” command, a “collection-mo-list” command, a “default-mo-list” command, a “root-dm-gen-flag” command, a “root-dm-class-name” command, a “generate-make-file-flag” command, a “make-file-name” command, a “compact-mo-gen-flag” command, a “row-status-flag” command, an “enforce-enum-flag” command, a “generate-root-classes-flag” command, a “mo-impl-name” command, and a “mo-impl-gen-flag” command.

21. The method as set forth in claim 19, further including the step:
e) initiating the processing step with a command with one or more command line options for customizing operation of the processing step, wherein the processing is subsequently performed in accordance with the one or more command line options in the initiate processing step command.

22. The method as set forth in claim 21 wherein the initiate processing step command includes at least one of a first command line option that specifies a resource definition line file to be processed, a second command line option that specifies persistent manage objects to be processed, a third command line option that specifies managed objects that are implemented by other managed objects, a fourth command line option that specifies a storage location for the programming language classes, database definition files, and script files, a fifth command line option that specifies the options file to be used for customizing the processing step, a sixth command line option that specifies a storage location for a DDE file generated during the processing step for subsequent use by a DDE ADS tool for data range checking, a seventh command line option that specifies a trigger method to be registered during the processing step, and an eighth command line option that instructs the processing step to accept strings larger than 2000 characters for generation of data definitions.

23. A method of defining a network to facilitate development of an application program to manage the network, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network created in the parsing step includes a parse tree; and
c) processing the parse tree to form one or more programming language classes, wherein the one or more programming language classes formed include at least one of one or more system classes, one or more module classes, one or more managed object classes, and one or more composite attribute classes.

24. The method as set forth in claim 23 wherein the one or more system classes include at least one of an adapter definition class, a Root Dm class, and an Nmake class.

25. The method as set forth in claim 23 wherein the one or more module classes include at least one of an attribute names and factory registration class, an enum definitions class, an enum attribute and factory definition class, and an managed object definitions class.

26. The method as set forth in claim 23 wherein the one or more managed object classes include at least one of a transient managed object class, a selective managed object class, a collection managed object class, and a persistent managed object class.

27. The method as set forth in claim 26 wherein the one or more managed object classes includes a selective managed object class and further includes an implementation class associated with the selective managed object class.

28. The method as set forth in claim 26 wherein the one or more managed object classes includes a collection managed object class and further includes at least one of a managed object handle class and a Dm class, wherein the at least one of the managed object handle class and Dm class are associated with the collection managed object class.

29. The method as set forth in claim 26 wherein the one or more managed object classes includes a persistent managed object class and further includes at least one of a managed object handle class, a specialized adapter class, and a Dm class, wherein the at least one of the managed object handle class, specialized adapter class, and Dm class are associated with the persistent managed object class.

30. The method as set forth in claim 23 wherein the one or more programming language classes are formed in a C++ programming language.

31. A method of defining a network to facilitate development of an application program to manage the network, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network includes object meta-data; and
c) processing the object meta-data to form one or more programming language classes, one or more database definition files, and one or more script files, wherein the one or more programming language classes formed include at least one of an index class and a query class.

32. The method as set forth in claim 31 wherein the one or more database definition files include at least one of data definitions, trigger definitions, and database schema.

33. The method as set forth in claim 31 wherein the one or more script files are formed in corresponding Unix shell scripts.
